(19) United States
(12) Patent Application Publication
(10) Pub. No.: US 2026/0317179 A1
(43) Pub. Date: Oct. 15, 2026

(54) LOW CARBON EMISSION PROCESS FOR THE PRODUCTION OF SILICON

(71) Applicant: HPQ SILICON INC., Montreal (CA)

(72) Inventors: Ali SHAHVERDI, Verdun (CA); Pierre CARABIN, Montreal (CA)

(21) Appl. No.: 19/113,780

(22) PCT Filed: Sep. 20, 2023
(86) PCT No.: PCT/CA2023/000025

§ 371 Date: Mar. 20, 2025

(51) Int. Cl. C01B 33/025; B01D 53/00; B01D 53/62; C01B 32/05; C01B 32/40

(52) U.S. Cl. CPC C01B 33/025; B01D 53/007; B01D 53/62; C01B 32/05; C01B 32/40; B01D 2257/502; B01D 2259/818

(57) ABSTRACT

A process is disclosed of making silicon by carbothermic reduction of silica having a low carbon footprint, low NOx emission, and reduced resource usage in the form of carbon. Also disclosed is a carbon capture method for a silicon making process by carbothermic reduction of silica using a combination of thermal plasma and high-pressure disproportionation of CO (g).

### CROSS REFERENCE TO RELATED APPLICATIONS

This application claims priority on U.S. Provisional Application No. 63/408,442, now pending, filed on Sep. 20, 2022, which is herein incorporated by reference.

### FIELD

The present subject matter relates to the production of elemental silicon, and, more particularly, to the production of elemental silicon in an arc furnace.

### BACKGROUND

Elemental silicon has numerous industrial applications, for example in the steel, automotive, microelectronics and solar industries. Silicon in the form of silicates represent 90% of the earth's crust, making in the second most abundant element in the earth's crust. However, silicon in its silicate form cannot be used directly in such industrial applications. Silicon for example in the form of quartz, SiO₂, must be reduced to its elemental form, Si.

Elemental silicon for industrial applications can have a wide range of purities. For example, as an alloying element in steel, silicon with a purity between 95% and 99% is typically used. This is referred to as metallurgical grade silicon. For high-end applications such as the microelectronics, high purity silicon is required, typically 99.9999999%.

The production of elemental silicon relies on the production of metallurgical grade silicon by carbothermic reduction of silica by electric arc smelting process. In this process, quartz SiO₂ is reduced to silicon in the presence of a source of carbon such as coal, petcoke or charcoal, by heating it in an electric arc furnace to high temperatures exceeding 1800° C.

In this process, carbon reacts with the oxygen in silicon dioxide SiO₂ to generate gaseous carbon monoxide and elemental silicon. The overall stoichiometric reaction leading to silicon is:

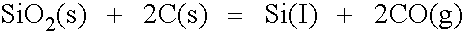

The process is carried out with an excess of silicon dioxide to prevent the production of silicon carbide SiC.

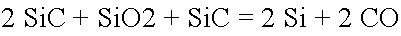

These reactions are highly endothermic and take place at high temperatures, exceeding 1800° C. Due to the endothermic nature and high temperature required, the process requires a great amount of electrical energy reaching between 13 and 15 kWh per kg of silicon produced at industrial scale.

The process takes place in an electric arc furnace (EAF) where the energy is supplied by a submerged electric arc, meaning that the arc is created and maintained inside the reacting load of quartz and carbon.

The highest temperature in the furnace, well above 2000° C., is observable where the arc is maintained, deep down inside the load. At that point in the furnace, the reduction reactions of silica generate CO (g) which travels upward and leaves the load at elevated temperatures, 1000-1300° C. [Ref. 1].

Due to size and complexity of these type of furnaces, they are built with an open top, which means that air can easily infiltrate the furnace and the oxygen in the air react with CO (g) in the hot process gas to produce CO2 (g). Nitrogen in the air is heated up to its reacting state resulting in NOx generation by reacting with oxygen. Both of these by-products, CO2 (g) and NOx, are pollutants to the environment, whereby CO2 (g) contributes greatly to the global warming since it is a potent greenhouse gas, and NOx contributes to acid rain, eutrophication, photochemical air-pollution, and depletion of the ozone layer and has detrimental effects on human health [Ref. 2].

In a commercial silicon plant, the direct emission of CO2 (g) can be as high as 5 kg/kg of silicon produced [Ref. 3]. The global footprint of silicon production attained 11.3 kgₑ of CO2 per kg of silicon produced [Ref. 4].

Apart from the process emission of carbon in the form of CO₂ (g), the initial carbon, a nonrenewable resource, is consumed through the carbothermic reduction of silica. Common sources of carbon in silicon making industry are coal, coke, petroleum coke (petcoke), wood chips and charcoal. The first three can be classified as fossil carbon materials and the rest are referred to as bio-sourced materials. In a silicon plant, it is common practice to use a mixture of the above-mentioned carbon sources, with the greater portion (>60 wt. %) being of the fossil-based type, namely coal, coke and petcoke. On average, about 1.5 kg of carbon is irreversibly consumed in the furnace for producing 1 kg of silicon.

It would therefore be desirable to develop a silicon production process that reduces carbon dioxide CO₂ emissions, nitrous oxide NOx emissions and reduces the use of non-renewable carbon.

NOx emissions from industrial processes can be reduced by capturing the NOx in the offgas stream through the selective catalytic reduction (SCR) or selective non catalytic reduction process (SNCR). However, due to the highly diluted gas from the open top furnace used in industrial processes, the NOx abatement towers become prohibitively large and costly.

It may be possible to capture the CO₂ from the silicon making furnace using for example an amine process. However, due to the highly diluted CO₂ in air, the process becomes non economically viable The most advanced flue-gas-capture solvents used today for absorbing CO₂ from industrial gas streams are aqueous solutions of amines, particularly monoethanolamine. Even in the best case, the primary energy required to strip CO₂ from the rich amine stream (115-140 KJ/mol CO₂) dominates the energy requirements of the process [Ref. 5]. The main limitations of such processes are the high energy intensity, also referred to as an energy penalty, and the loss of sorbent since all the sorbent entering the stripper does not get regenerated [Ref. 6]. Ethanolamine also presents some health risks, as it can cause damages to the liver and kidneys, while high exposure can cause damage to the nervous system. Moreover, the captured CO₂ must be either sequestered, stored or used offsite, resulting in additional CO₂ emissions in the transportation, leaks and inefficiencies.

To the end of reducing CO₂ emission from the silicon making process, several industrial initiatives have been developed. It has been proposed to, for example, replace the nonrenewable carbon with biocarbon produced by pyrolysis, and use a closed type EAF, so to limit the oxidation of CO into CO₂. The CO would then be used for other industrial applications [Ref. 7].

The use of biocarbon has several drawbacks, including the high energy requirements required to produce the biocarbon from biomass such as wood, the limited capacity of the earth to produce biomass, displacing useful land use from agriculture and the fact that the carbothermic reduction of the biocarbon ultimately results in the release of CO₂ into the atmosphere.

Elkem, one of the major silicon producers in the world, in collaboration with NTNU and SINTEF are investigating off-gas recirculating as a possible way to improve the carbon capture process [Ref. 8] by increasing the CO₂ concentration in the off-gas. In a conventional silicon making process, the concentration of CO₂ is relatively low in the order of a few percent, making CO₂ capture process not economically viable. By recirculating the off-gas back to the furnace, the concentration of CO₂ can be increased over 20% making the conventional CO₂ process more affordable. It is not clear however, how the air infiltration is avoided in silicon smelters that utilize open submerged arc furnaces. One can propose the use of a closed electric arc furnace as described in PCT Publication No. WO 2020/243812 A8 referred to below. Nonetheless, even if CO₂ is captured efficiently and economically viable, it cannot be utilized in the silicon making process itself and is required to be sequestrated and stored.

In U.S. Pat. No. 4,860,096, a closed furnace equipped with a transferred arc plasma arc torch is proposed to produce silicon from conventional raw materials. The inventors claim that using a transferred arc torch in lieu of a graphite electrode is advantageous, as it theoretically requires less energy compared to a transferred plasma arc for the carbothermic reduction of SiO₂ to Si. Furthermore, the inventors claim that a higher quality silicon product is expected since the use of a graphite electrode is avoided. However, the actual yield of SiO2 to Si using such process is unknown, as opposed to the well-proven submerged arc process yielding 85-90% conversion. This yield parameter is very important to assess the energy efficiency of the process. One additional drawback of such a furnace is the use of water cooling required to operate a transferred plasma arc torch. Water cooling may lead to leakage of water from the torch onto the molten silicon bath which can result in a catastrophic steam hammering and explosion. Moreover, the potential for scaling up of such a furnace is questionable since the commercially available transferred arc torches are rated at much lower powers, a few megawatts at best, than those required for full-scale silicon making production, which is in the order of several hundreds of megawatts.

A closed EAF has been proposed for example in aforementioned PCT Publication No. WO 2020/243812 A8 which describes a consumable electrode vacuum arc furnace and, more particularly, a direct current consumable electrode vacuum arc furnace, wherein no water cooling is needed to cool down typically neither the electrodes, nor any other parts of the furnace, and this includes the shell, the flange ports and the electrical connections of the furnace.

This type of closed furnace minimizes the formation of CO₂ (g) by minimizing air infiltration into the furnace leaving the furnace gas rich in CO (g).

CO (g) in its original form is considered a building block of many useful chemicals including but not limited to methanol, ethanol, and formic acid. Therefore, one can see that the main advantage of such a closed EAF over an open EAF from the environmental point of view, as it allows for the recovery of CO (g) as the main by-product of the carbothermic reduction of the silicon making process. However, from a global economy and market requirements point of view, this first step does not provide a viable solution towards a low carbon emission silicon process because CO (g) produced this way can only be used in another industrial process or a secondary process. For instance to make useful chemicals such as methanol by catalytic synthesis, severe requirements in terms of CO (g) quality, availability and consumption rate are imposed. Therefore, under this approach, CO (g) from silicon production needs to be stored and might require further upgrading until it can be used in the secondary processes whenever and wherever possible depending on market demand and CO (g) shortage. Hence one can also expect that the CO (g) requires transportation to the secondary process sites by means of conventional transportation dependent on burning fossil-fuels which in turn emits CO2 (g). In addition, there is a loss of CO (g) in the secondary processes to be converted to the useful chemicals since the yield of such industrial processes does not reach to 100% resulting in a higher carbon footprint.

Due to the ever-increasing demand for silicon, and use of fossil carbon in an unsustainable manner, a circular process for making silicon through carbothermic reduction is required in which the carbon is captured and is returned to the process.

Therefore, there is a need for an environmentally friendly silicon making process having a low carbon footprint, reducing the consumption of limited natural resources, and having low pollutant emissions such as NOx.

### SUMMARY

It would thus be desirable to provide a novel silicon production process.

The embodiments described herein provide in one aspect a process of making silicon by carbothermic reduction of silica having a low carbon footprint, low NOx emission, and reduced resource usage in the form of carbon.

Also, the embodiments described herein provide in another aspect a carbon capture method for silicon making process by carbothermic reduction of silica using a combination of thermal plasma and high-pressure disproportionation of CO (g).

Furthermore, the embodiments described herein provide in another aspect a process of combined thermal plasma decomposition-ultra fast quenching-disproportion of CO (s) generated using a closed electric arc furnace from carbothermic reduction of silica to silicon to solid carbon.

Furthermore, the embodiments described herein provide in another aspect a process of producing highly concentrated stream of CO (g) from carbothermic reduction of silica to silicon.

Furthermore, the embodiments described herein provide in another aspect for a use of a closed electric arc furnace to minimize presence of excess air and/or oxygen during carbothermic reduction of silica to silicon for the purpose of capturing carbon.

Furthermore, the embodiments described herein provide in another aspect a process of forming a stream of plasma gas from pure or concentrated CO (g) stream to form solid carbon by thermal decomposition.

Furthermore, the embodiments described herein provide in another aspect an ultra-fast quenching process of CO (g) plasma generated by means of a plasma torch using a converging-diverging nozzle to convert thermal energy of plasma gas to kinetic energy to reduce its temperature very quickly to maximize formation and recovery of carbon in solid form.

Furthermore, the embodiments described herein provide in another aspect for a use of inert/and or reducing quench gas(es) after converging-diverging nozzle to avoid back reaction of carbon with oxygen to enhance carbon recovery from CO (s) plasma stream.

Furthermore, the embodiments described herein provide in another aspect a high-pressure/moderate temperature process of CO (g) disapprobation to solid carbon with or without use of catalyst.

Furthermore, the embodiments described herein provide in another aspect a process of recycling carbon in silicon making from carbothermic reduction of silica by pelletizing carbon (captured from CO (g) stream from a closed electric arc furnace) and silica containing materials.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 is an exemplary schematic diagram of a process for the production of silicon with carbon recycling, in accordance with an exemplary embodiment;

FIG. 2 is an exemplary schematic diagram of a silicon making process with carbon capture, in accordance with an exemplary embodiment;

FIG. 3 is an exemplary schematic vertical cross-sectional view of a plasma torch and quench module for the first step carbon capture, in accordance with an exemplary embodiment;

FIGS. 4a and 4b are a pair of charts showing a thermodynamic equilibrium composition of CO (g) at a wide range of temperature (100-10000° C.), wherein FIG. 4a has a Y axis in kmol and an X axis in Temperature (° C.), and wherein FIG. 4b has a Y axis in Log (kmol) and an X axis in temperature (° C.);

FIG. 5 is a chart showing a composition of CO plasma at 1 atm;

FIG. 6 is a chart showing a degree of ionization of CO plasma at 1 atm; and

FIGS. 7a, 7b, 7c and 7d are four (4) charts showing a thermodynamic equilibrium of C—O reaction system, respectively in order, at 400, 600, 800 and 1000° C. at 1-200 bar pressure range.

### DESCRIPTION OF VARIOUS EMBODIMENTS

The aforementioned drawbacks can be at least partly overcome by the present subject matter that uses a two-step process for carbon capture and reuse in the production of silicon by means of the conventional carbothermic reduction of silica to silicon. In the first step, there is provided means of producing clean CO (g) from the carbothermic reduction furnace. In the second step, there is provided a mean to recover carbon from the CO (g) and then return this carbon to the carbothermic reduction step.

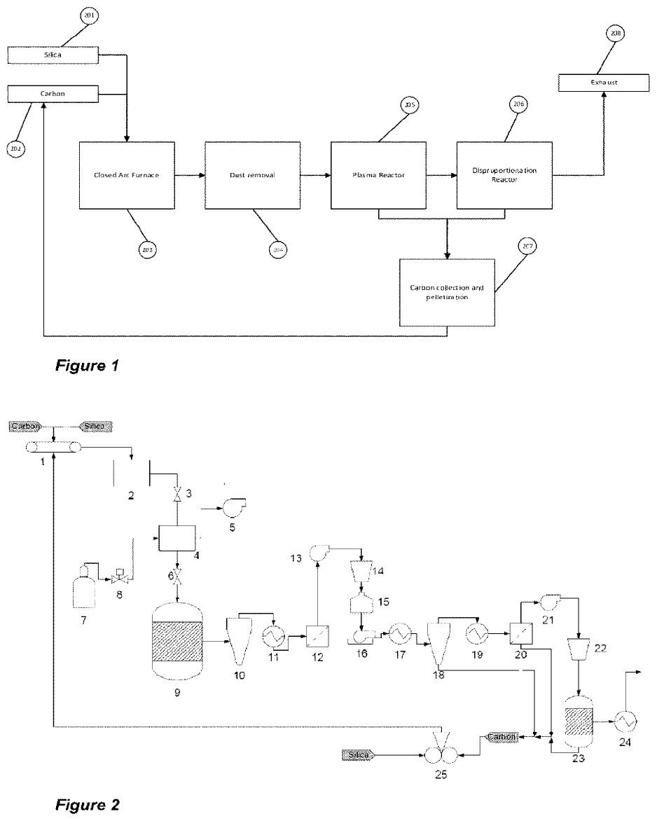

Referring to FIG. 1, there is shown a schematic diagram of a process for the production of silicon with carbon recycling, wherein silica 201 and carbon 202 are fed continuously to a closed electrical arc furnace (CEAF) 203. The CEAF 203 can operate under vacuum, at atmospheric conditions or be exposed to an induced draft to avoid fugitive emissions into the environment. In circumstances requiring very low NOx and CO₂ emissions specifically at the beginning of the carbothermic reduction process, a vacuum rated CEAF is preferable for allowing to minimize the residual oxygen in the furnace before energizing it by the electric arc and also during the operation when a negative operating pressure (i.e. below atmospheric pressure) is applied.

The CEAF 203 minimizes the formation of CO2 (g) by minimizing air infiltration into the furnace leaving the furnace gas rich in CO (g), meaning that CO (g) from the carbothermic reduction process in the furnace cannot be oxidized by oxygen in air from the surroundings.

The reacting environment in the CEAF 203 is controlled by means of a closed construction that minimizes air infiltration, meaning that the presence of nitrogen from air in the furnace environment is minimized to zero. This results in the inhibition of the formation of NOx by the reaction of nitrogen and oxygen from air at high temperature.

The CO (g) stream free of NOx contains a notable quantity of particulates in the form of silica fume which is a by-product of an incomplete reduction reaction of SiO₂ to Si. In order to further process CO (g), particulate matters are filtered out in a dust removal step 204.

The CO (g) stream now free of particulates enters a process of decarbonization by which solid carbon is recovered and can be returned to a silicon plant to re-react with silica. The combination of the first step by which CO (g) is recovered and the second step by which carbon is extracted from CO (g), enables to have an onsite circular carbon usage for the silicon making process.

To capture carbon from CO (g), two methods can be used.

The first method occurs in a plasma reactor 205 where CO (g) is fed into a plasma which can conduct electrical current and by which CO (g) temperature can be increased to a level where C and O can coexist in their elemental form. The global reaction can be written as:

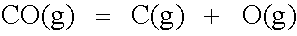

The second method occurs in a disproportionation reactor 206 where the CO (g) molecules react at an elevated temperature and pressure to extract 1 mole of C in solid form from two moles of CO (g). The global reaction can be written as:

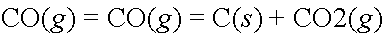

Each method can be utilized in sole (alone) or combined to maximize the carbon recovery yield.

The carbon from the two methods (205 and 206) goes through a carbon collection and pelletization step 207 before being mixed with silica 201 where it can then be fed back to the CEAF 203 to produce additional silicon.

A remaining exhaust gas 208 exits the process through a stack.

Referring to FIG. 2, there is shown an exemplary schematic diagram of a new silicon making process with carbon capture. Silica, for instance in the form of quartz, and carbon, for example in a form of coal, coke, charcoal, and wood chips and/or of a mixture of those, are transported by a conveyer 1, to an open hopper 2 used for temporary batch storage. The mixture of carbon and silica can then be fed to a closed hopper 4 that is isolated from the open environment via an airtight valve 3 such as a gate valve.

The closed hopper 4 is connected to a vacuum pump 5 that is used to remove the residual air from the closed hopper 4 and isolated from a CEAF 9.

To minimize the formation of NOx at the start of the process, once the closed hopper 4 and the CEAF 9 are degassed using the vacuum pump 5, argon gas is injected from a source 7 by opening a valve 8 that closes once the pressure inside the CEAF 9 reaches atmospheric level. This degassing process should be repeated to ensure removal of residual air from the system.

To load the CEAF 9, the valve 3 opens to unload the mixture of carbon and silica into the closed hopper 4, and then closes. The vacuum pump 5 then runs to remove the air trapped in the closed hopper 4 by a degassing process of back filling the closed hopper 4 with argon from the source 7 via the opening and closing of the valve 8.

Afterwards, a valve 6 opens to unload the mixture of feedstock such as quartz and carbon into the CEAF 9.

The carbothermic reduction of silica, for instance in the form of quartz, and carbon source takes place in the CEAF 9 without the presence of air, which results in the low emission of NOx from the process, and formation of hot CO (g) rich stream.

The hot CO (g) rich stream leaves the CEAF 9 with particulate of fine silicon oxide from incomplete reduction reaction of silica and carbon. The hot gas stream is cleaned from the majority of fine particulate matters via a hot cyclone 10 such as a refractory lined cyclone allowing to handle hot gas.

The gas leaving the hot cyclone 10 is directed towards a heat exchanger 11 where the gas temperature is lowered, for instance below 150° C. The cooled down gas can then be cleaned of residual particulate matters that were not captured by the hot cyclone 10 by means of a high efficiency filter system 12 such as a baghouse filter that can be combined with a HEPA filter to maximize the particulate removal efficiency.

The CO rich gas stream now free from particulate matter is driven by means of an induced draft (ID) fan 13. The ID fan 13 ensures that the operational process pressure is kept slightly under atmospheric pressure to avoid any fugitive emissions of CO (g) into the surroundings and to ensure the safety of the operators.

A gas compressor 14 increases the pressure of the CO (g) rich stream to a moderate level high enough, for instance up to 10 atm, to enable the proper operation of a plasma torch 16.

A buffer tank 15 is required to maintain the pressure of the CO (g) during the operation of the plasma torch 16. Pressurized CO (g) enters the plasma torch 16 where it decomposes to C (g) and O (g). C (g) containing plasma enters a quench system 17 capable of preventing the backwards reaction of C (g) and O (g) to CO (g) with high efficiency so that the reformation of CO (g) is minimized. Another role of this quench system 17 is to lower the temperature of the plasma gas to a point where carbon gas C (g) condenses to its solid form C(s).

Once formed, C(s) remains stable in the quenched gas stream and enters a cold cyclone 18 by which C(s) is mostly separated from the gas stream through the cyclonic effect of the flow.

The gas leaving the cold cyclone 18 shall be further cooled down by means of a heat exchanger 19, and cold enough, for instance below 150° C., to be filtered by means of commercially available filter materials that can be utilized in a filtration system 20 such as a baghouse, that can be combined with HEPA filters to maximize the removal efficiency of remaining C(s) from the gas stream.

The remaining CO (g) stream, cleaned from C(s), is driven by means of a gas blower 21 into a gas compressor 22 to increase its pressure to a selected value, for instance from Table 1 (hereinbelow), for its further processing into a CO (g) disproportionation reactor 23 that can be operated up to 100 atm and at high temperatures, for instance 800° C., to convert a portion of CO (g) to C(s). For instance, if a CO (g) conversion yield of 75%, which results in a recovery ratio of 30% to C(s), is required, the reactor 23 shall be operated at 25 atm at a temperature of 800° C. To enhance the reaction process and to reduce the energy requirement of such a disproportionation process, catalyst material such as iron can be used.

The hot gas leaving the disproportionation reactor 23 is cooled down by means of a heat exchanger 24 before being venting out to atmosphere. To avoid emission of harmful CO (g) to the atmosphere, the remaining CO (g) can be oxidized to CO₂ (g) by means of a thermal oxidizer. The concentrated CO2 (g) stream at that point can be further concentrated and reused offsite for useful industrial or commercial usage.

The C(s) collected from the reactor 23 is then transferred to a briquetting/pelletizing unit 25 along with C(s) collected from the cold cyclone 18 and the filtration system 20 to be mixed with quartz so that a portion of carbon from the main carbothermic reduction of silica to silicon is returned to the process enabling a circular carbon use within the process.

Thermal plasma can be formed by means of several methods known to the expert in the field, including but not limited to alternative and direct current electric arc, radio frequency inductively coupled source (RF-IC), and microwave. Among these methods, electric arc and RF-IC are of interest since they have been used in industrial thermal plasma torches, they can treat high flow of gas, and more importantly they can generate very high temperature plasmas, which is the requirement of the plasma torch 16 for this process. Ideally, the plasma torch 16 can raise the temperature of bulk CO (g) to 8000° C., in order to maximize the dissociation yield of CO (g) to C (g), and not lower than 5000° C. to maintain C (g). A combination of two or more methods for thermal plasma generation is also possible. For instance, one can combine an electric arc generated plasma with RF-IC source, to increase the volume of gas and/or the residence of CO (g) in the hot plasma zone.

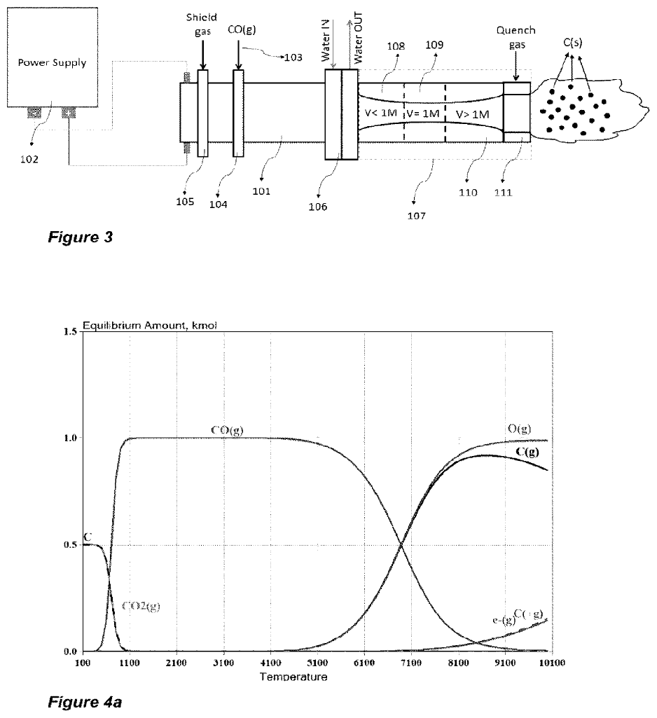

Referring to FIG. 3, there is shown an exemplary schematic vertical cross-sectional view of the plasma torch 16 and quench module 17 for the first step carbon capture. A plasma torch 101 is electrically energized by a power supply 102, and the CO (g) stream 103 enters the torch 101 at one or more locations, for instance via a gas distributor(s) 104 in the case of using a direct current (DC) electric arc torch in which the power level can be augmented by increasing the arc voltage via a higher flow of the plasma gas.

A shield gas such as argon is injected through a gas distributor 105. The ratio of the shield gas over plasma forming gas can be as low as 10% or even less. The use of shield gas is not required for an arc plasma torch with a configuration of tubular electrodes or a configuration of coaxial electrodes, made of, for instance, copper. This is advantageous since the gas stream stays rich in CO (g). The front end of the plasma torch 106 is a water-cooled flange that can be connected directly to the quench module 107 having a converging-diverging shape that allows the hot plasma gas to reach velocities over 1 Mach, in the diverging zone. The plasma gas entering the quench module 107 is compressed in a converging zone 108 so that the gas velocity reaches 1 Mach in a through zone 109. Once it enters a diverging zone 110, the plasma gas expands so that its thermal energy is converted to kinetic energy while reaching a velocity of over 1 Mach. A cooling rate of >5×10⁷° C./s [Ref. 9] ensures the conversion of C (g) in the plasma to C(s). Since the residence time of plasma CO (g) in the quench is limited due to it high velocity, a partial conversion of CO (g) to C(s) is expected. To enhance the quenching process even further, a quench gas such as inert gases (e.g. Ar, He, N2) or reducing gases such as CO (g), H2 (g), or CH4 (g), or a combination of gases shall be injected through a gas distributor 111. The cold quench gas comes into contact with the gas emerging from the diverging zone 110 so that the total temperature of the gases drop, further avoiding the back reaction of C(s) with oxygen. The remaining CO (g), not converted to C(s), is further proceeded by the disproportionation reaction as explained in previous section to maximize the total carbon capture yield.

It is further presented by way of two examples how solid carbon can be produced from gaseous CO in the plasma reactor and in the disproportionation reactor.

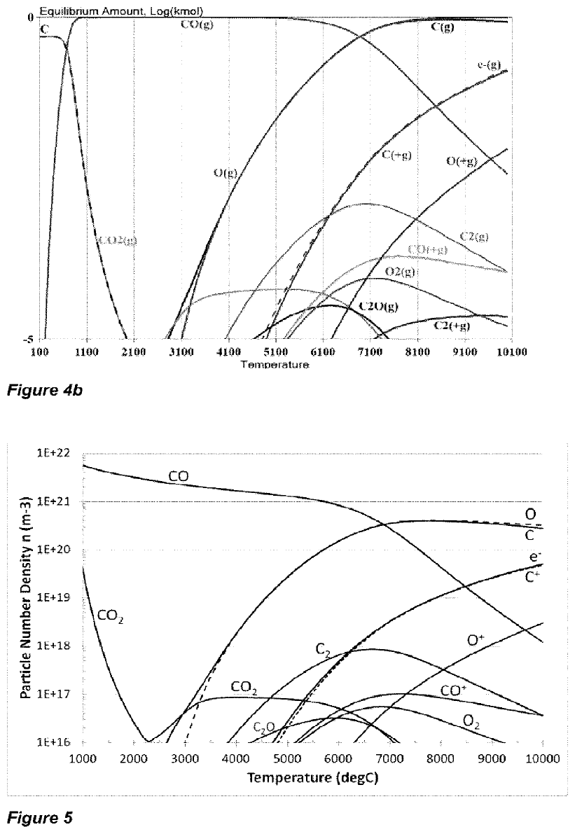

Method 1—CO plasma for carbon capture. Assuming local thermodynamic equilibrium of thermal plasma, it is possible to predict the plasma composition of carbon monoxide using Gibbs free energy minimization approach. C—O thermodynamic equilibrium composition can then be calculated at a wide temperature range. Using HSC commercial software v. 8, carbon monoxide plasma composition was calculated, and the results are shown in FIGS. 4 to 6. In order to predict the plasma state temperature for CO, it is necessary to define the plasma. For a gas to be considered a plasma, there should be enough ionized species present. As a general rule, if a gas is at least 1% ionized (degree of ionization), it can be considered plasma (to account for high electrical conductivity). The degree of ionization can be written as follows:

$$α = \frac{{n}_{i}}{{n}_{i} + {n}_{n}}$$

Where nᵢ and nₙ are number density of ions and neutral species, respectively.

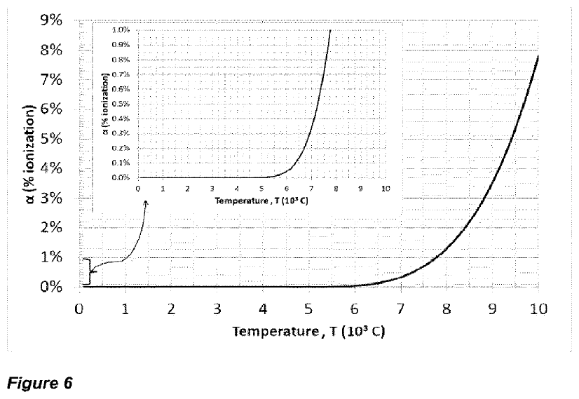

It is necessary to calculate the particle number density of CO gas at various temperatures in order to calculate degree of ionization. FIG. 5 shows the calculated particle number density of CO plasma at atmospheric pressure. Having the number density of particles, it is possible to estimate the degree of ionization of plasma at various temperatures according to the above-mentioned formula. The results of this calculation are presented in FIG. 6.

As seen in FIG. 6, below 6000° C., the degree of ionization is very low (<0.05%). At 7800° C., the degree of ionization of CO plasma reaches 1%. Therefore, it can be said that CO plasma forms at temperatures above 7800° C.

However, dissociation of CO to monatomic substances (i.e. C, and O) starts at much lower temperatures, around 3000° C., where their number density becomes greater than 10¹⁶ m⁻³. As seen in FIG. 6, CO atomizes to free O (g) and C (g) atoms at temperatures over 8000° C. At above 10 000° C., the composition of plasma is mostly atomic oxygen and carbon. If a very high quench rate is possible, then carbon can be directly transformed to solid phase and be captured. The rate of quench should be higher than that of CO formation kinetics at lower temperatures.

Carbon formation is thermodynamically favourable at lower temperatures (<2100° C.) as seen in FIG. 4 through possibly this reaction: CO+CO=C+CO2. This implies that in a reaction system comprised of CO, it is thermodynamically favourable that carbon and CO2 (g) form and CO (g) should decay to these species.

Method 2: CO dissociation for carbon capture. Dissociation of CO to carbon has shown to be possible through disproportionation reaction of two moles of CO to one mole of carbon and one mole of CO2:

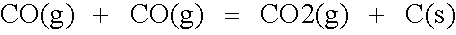

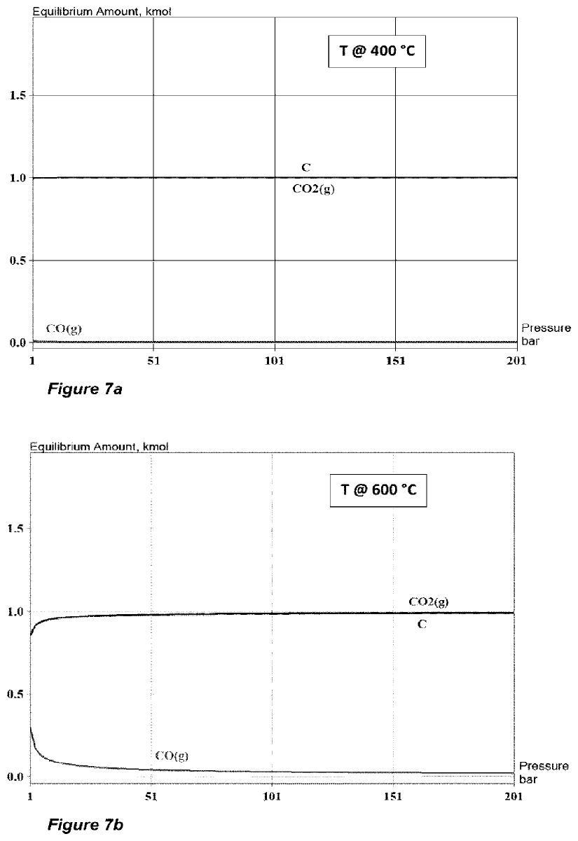

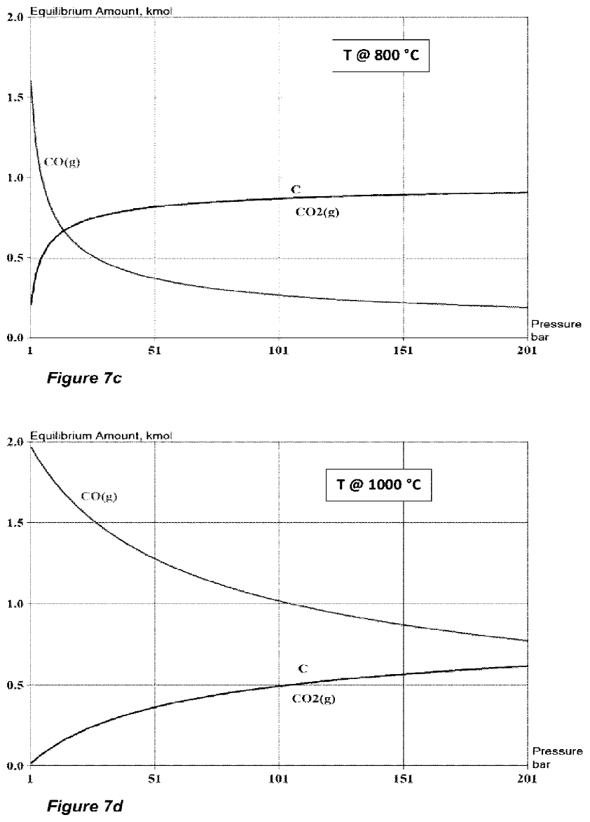

If the reaction is possible, then due to the volume reduction of gaseous reactants (2 mole of CO (g) to 1 mole of CO2 (g)), it is expected that the reaction should proceed at higher pressures and to slow down the back reaction of C with CO₂, low temperatures should be favorable. Indeed, the results of thermodynamic calculation agree with this expectation as shown in FIG. 7.

According to the results presented in FIG. 7, thermodynamically, CO tends to transform to CO₂ and C at low temperatures. However, this reaction is expected to be very slow. To increase the reaction rate, CO conversion to CO₂ can be performed at a higher temperature if the pressure increases. For instance, if the reaction temperature increases from 400° C. to 800° C., almost the same carbon conversion yield can be obtained at pressures over 100 atm.

The results of thermodynamic equilibrium calculation on the C—O system at 800° C. and at various operating pressures are summarized in Table 1. Simply, the higher the reaction pressure is, the higher the carbon conversion yield becomes.

TABLE 1
Thermodynamic equilibrium composition
of C—O system at 800 °C*

| Species | Pressure (atm) | | | | | |
|---|---|---|---|---|---|---|
| (mole) | 1 | 5 | 10 | 25 | 50 | 100 |
| CO | 0.7955 | 0.5063 | 0.3834 | 0.2539 | 0.1825 | 0.1302 |
| CO2 | 0.1022 | 0.2468 | 0.3083 | 0.3730 | 0.4078 | 0.4349 |
| C | 0.1022 | 0.2468 | 0.3083 | 0.3730 | 0.4087 | 0.4349 |

*FACTSAGE WEB CODE v. 7.1

It is therefore theoretically demonstrated that it is possible to extract carbon in solid form from CO (g) by using a non-transferred DC plasma torch followed by extreme quench and high pressure-moderate temperature catalytic processing of remaining CO (g) to capture more carbon.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

[1] Nils Eivind Kamfjord, Mass and Energy Balances of the Silicon Process (2012), PhD Thesis, Norwegian University of Science and Technology
[2] Edin Henrik Myrhaug, Halvard Tveit, Nils Eivind Kamfjord, GeirJohan Andersen and Åslaug Grøvlen, NOx Emissions from Silicon Production (2012), Silicon for the Chemical and Solar Industry XI Bergen-Ulvik, Norway
[3] T. Lindstad1,2, S. E. Olsen1,2, G. Tranell2, T. Færden3 and J. Lubetsky, Greenhouse Gas Emissions from Ferroalloy Production (2007), INFACON XI, New Delhi, India, 18-21
[4] Gudrun Saevarsdottir, Thordur Magnusson, and Halvor Kvande, Reducing the Carbon Footprint: Primary Production of Aluminum and Silicon with Changing Energy Systems, Journal of Sustainable Metallurgy (2021), 7:848-857
[5] K. Z. House, A. C. Baclig, M. Ranjan, E. A. van Nierop, J. Wilcox, and H. J. Herzog, Economic and energetic analysis of capturing CO₂ from ambient air (2011), PNAS, 108 (51) 20428-20433
[6] IECM Technical Documentation: Amine-based Post-Combustion CO2 Capture (2018)
[7] Elkem, The road to climate neutral metal production [https://www.elkem.com/innovation/long-term-rd/the-road-to-climate-neutral-metal-production/]
[8] I. Solheim, V. Andersen, and R. Jensen, Recirculating off-gas contributes to carbon capture (2021) [https://www.sintef.no/en/latest-news/2021/recirculating-off-gas-contributes-to-carbon-capture/]
[9] Benny T. Kuan, and Peter J. Witt, Modelling supersonic quenching of magnesium vapour in a Laval nozzle (2013) Chemical Engineering Science Volume 87, Pages 23-39

1. A process of making silicon by carbothermic reduction of silica having a low carbon footprint, low NOx emission, and reduced resource usage in the form of carbon.

2. A carbon capture method for silicon making process by carbothermic reduction of silica using a combination of thermal plasma and high-pressure disproportionation of CO (g).

3. A process of combined thermal plasma decomposition-ultra fast quenching-disproportion of CO (s) generated using a closed electric arc furnace from carbothermic reduction of silica to silicon to solid carbon.

4. A process of producing highly concentrated stream of CO (g) from carbothermic reduction of silica to silicon.

5. Use of a closed electric arc furnace to minimize presence of excess air and/or oxygen during carbothermic reduction of silica to silicon for the purpose of capturing carbon.

6. A process of forming a stream of plasma gas from pure or concentrated CO (g) stream to form solid carbon by thermal decomposition.

7. An ultra-fast quenching process of CO (g) plasma generated by means of a plasma torch using a converging-diverging nozzle to convert thermal energy of plasma gas to kinetic energy to reduce its temperature very quickly to maximize formation and recovery of carbon in solid form.

8. Use of inert/and or reducing quench gas(es) after converging-diverging nozzle to avoid back reaction of carbon with oxygen to enhance carbon recovery from CO (s) plasma stream.

9. A high-pressure/moderate temperature process of CO (g) disapprobation to solid carbon with or without use of catalyst.

10. A process of recycling carbon in silicon making from carbothermic reduction of silica by pelletizing carbon (captured from CO (g) stream from a closed electric arc furnace) and silica containing materials.
